(19) United States
(12) Patent Application Publication
(10) Pub. No.: US 2017/0042758 A1
(43) Pub. Date: Feb. 16, 2017

(54) ERGONOMIC TRI-STIMULATION CLITORIS VIBRATOR

(71) Applicant: Shenda May Debra CREGAN, Sabadell (ES)

(72) Inventor: Shenda May Debra CREGAN, Sabadell (ES)

(21) Appl. No.: 15/115,882

(22) PCT Filed: Feb. 15, 2016
(86) PCT No.: PCT/ES2016/070087

§ 371 Date: Aug. 1, 2016

(30) Foreign Application Priority Data
Apr. 8, 2015 (ES) U201500260

(51) Int. Cl. A61H 19/00; A61H 23/02

(52) U.S. Cl. CPC A61H 19/34; A61H 23/02; A61H 2205/087

(57) ABSTRACT

A clitoris vibrator. It comprises a handle (4) that incorporates a motor (7) and a control button (3) that activates the motor (7) and at least one vibrating ball that is powered by the motor (7); comprising two flexible arms (1) that incorporate a vibrating ball (6) therein; and a connection point (5) of the two flexible arms (1) that incorporates a vibrating ball (6) from where the handle (4) extends. The flexible arms (1) form a V shape that imitates the structure of the inner clitoris thus meaning that, by placing the connection point (5) on the clitoral glans, the arms (1) adapt to the contours where the internal organs of the clitoris are located. Said arms (1) further comprise a narrow portion in the shape of an elbow (2), manufactured with flexible material; and a wider portion where the vibrating ball (6) is located. The portion of the arms (1) that comes into contact with the body has a rounded contour which enables the vibration pulse to be intensified.

15

### TECHNICAL FIELD

In the sector of erotic toys (for adults) for women, there are many different types of vibrating devices to stimulate the clitoris, normally concentrating stimulation solely around the clitoral glans (outer area of the clitoris), and not affecting other clitoral and adjacent areas capable of being stimulated.

The present invention simultaneously extends the area of stimulation to other additional erogenous zones that form part of the internal clitoris, such as the vestibular bulbs and the two crura (in plural, or crus in singular) that until now other devices have not taken into account.

### BACKGROUND OF THE INVENTION

On the market there are many devices aimed at stimulating the clitoris, which are focused on the clitoral glans.

### DESCRIPTION OF THE INVENTION

The clitoris is an organ that is much larger than one may think. Only taking into account its nature, the relevance of the clitoris is that it has approximately 8000 nerve endings. It measures between 10 and 13 centimeters, although when only looking at the external part, it seems much smaller. The rest is inside the body, within the pelvis. The clitoris forms a complex structure with various parts: a glans, a stem and two roots that run towards the inside of the body (crura) and are in contact with the inner labia of the vulva, the vaginal opening, the opening of the urethra and the inner part of the perineum. In other words, the structure of the clitoris is in contact with many other parts of the female genitalia.

This vibrating stimulator has a base with a V-shaped design, imitating the structure of the inner clitoris, and it has two flexible arms. Its ergonomic form is designed to adapt itself to the contours of a woman's vulva between the outer and inner labia where the inner areas of the clitoris are located, thus meaning that, by placing the connection point of the V on the clitoral glans, the flexible arms of the device adapt to the contours where the internal organs of the clitoris are located, such as the two crura and other sensitive organs of the clitoris.

From the connection point, there is an upwards handle so that the device can be held and where the control button is located. This button turns the device on and off and controls the different modes of vibration (intensities, speeds and frequencies).

The device contains a motor located inside the handle such that it may be controlled by the control button, and three vibrating balls, two on the arms of the V and one on the connection point which will come into contact with the clitoral glans.

The present design significantly enhances and improves current models that do not consider the characteristics and sensory capacities of the inner clitoris, going from one stimulation point to three localized stimulation points that take into account female anatomy in this area, substantially increasing a woman's possibilities for pleasure.

### BRIEF DESCRIPTION OF THE DRAWINGS

FIGS. 1, 2 and 3 show the front, side and top views of the vibrator, respectively, and

FIG. 4 shows a perspective view that allows the placement of the different components to be seen.

FIG. 5 shows an anatomical illustration of the internal clitoris and vaginal area that completes the explanation.

Point 1 corresponds to the V-shaped flexible arms, and point 2 is the elbow or point of flexibility of the arms for its adjustment.

Point 3 is the control button, and point 4 is the handle for holding.

Point 5 shows the connection of the three parts, the handle and the arms.

Point 6 shows the vibrating balls, two side balls in the arms and one on the connection point (5). The motor is located on point 7.

FIG. 5 shows the area where the device would be used, placing the connection point (5) on the clitoral glans (8), so that the flexible arms (1) and the elbow (2) would be placed on the vestibular bulbs (12) and the two crura (9). The inner labia (11), vagina (13) and urethra (10) complete the figure to provide a clearer illustration.

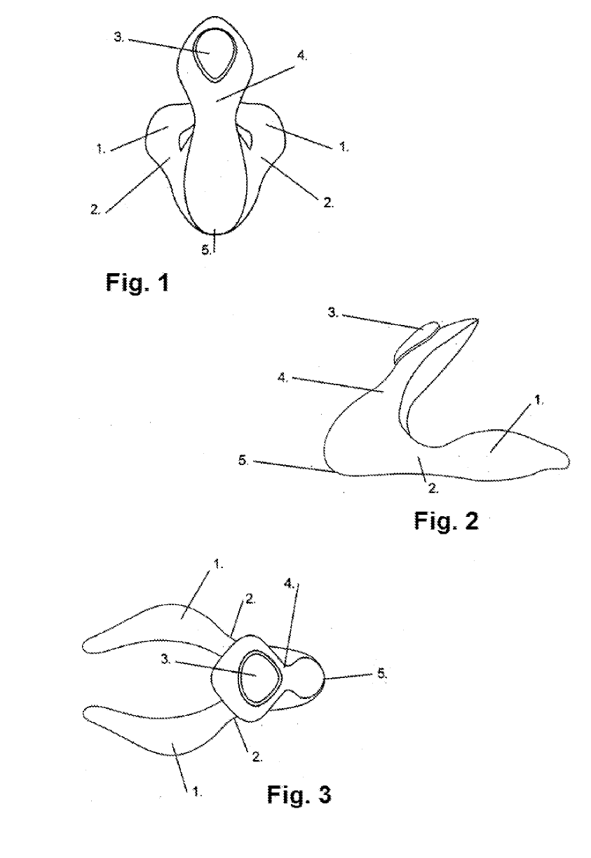

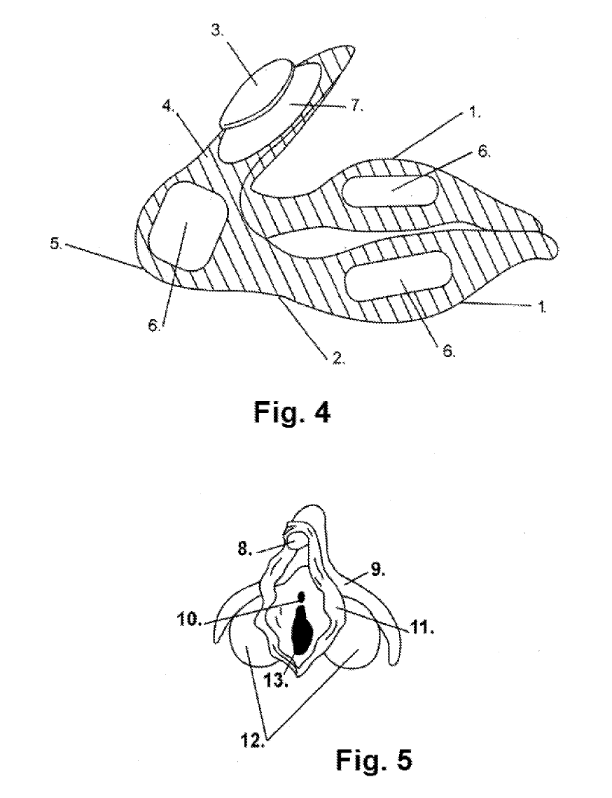

### PREFERRED EMBODIMENT OF THE INVENTION

The clitoris vibrator is made up of a single piece, with two arms in a V-shape, ergonomically designed to adapt to the contours of a woman's vulva, with a handle that enables easy and versatile handling and use.

The vibrator, object of the present Utility Model, will be manufactured with materials that are appropriate for its elements and components, using plastic, silicones suitable for the intended use (medical grade, or similar) or TPR (Thermo Poly Rock), and using balls, batteries or motors that are typically used in this type of device.

1. A clitoris vibrator comprising:
a handle (4) that incorporates a motor (7) and a control button (3) that activates the motor (7)
at least one vibrating ball that is powered by the motor (7)
characterized in that it further comprises
two flexible arms (1) that incorporate a vibrating ball (6) therein; and
a connection point (5) of the two flexible arms (1) that incorporates a vibrating ball (6) from where the handle (4) is extends
such that the flexible arms (1) that join at the connection point (5) form a V shape that imitates the structure of the inner clitoris, thus meaning that, by placing the connection point (5) on the clitoral glans, the arms (1) adapt to the contours where the internal organs of the clitoris are located.

2. The clitoris vibrator according to claim 1, characterized in that the arms (1) comprise:
a narrow portion forming an elbow (2) that is manufactured with flexible material; and
a wider portion where the vibrating ball is located (6).

3. The clitoris vibrator according to claim 1, characterized in that the portion of the arms (1) that comes into contact with the body has a rounded contour that enables the vibration pulse to be intensified.

4. The clitoris vibrator according to claim 1, characterized in that the flexibility of the arms (1) enable the angle that is formed by the arms (1) to be varied.

5. The clitoris vibrator according to claim 1, characterized in that the handle (4) comprises:
a narrow portion that is in contact with the connection point (5); and
a wider end portion where the motor (7) and the control button (3) are located such that it enables an ergonomic grip by the user.
